(19) United States
(12) Patent Application Publication
(10) Pub. No.: US 2015/0372516 A1
(43) Pub. Date: Dec. 24, 2015

(54) IDENTIFICATION MODULE CARD INCLUDING BATTERY PROTECTION CIRCUIT MODULE, AND PORTABLE WIRELESS DEVICE INCLUDING THE IDENTIFICATION MODULE CARD

(71) Applicant: ITM SEMICONDUCTOR CO., LTD., Chungcheongbuk-do (KR)

(72) Inventors: Hyeokhwi NA, Chungcheongbuk-do (KR); Hoseok HWANG, Gyeonggi-do (KR); Youngseok KIM, Chungcheongbuk-do (KR); Sungbeom PARK, Gyeonggi-do (KR); Sanghoon AHN, Chungcheongbuk-do (KR); Sunho KIM, Gyeonggi-do (KR)

(21) Appl. No.: 14/729,482

(22) Filed: Jun. 3, 2015

(30) Foreign Application Priority Data
Jun. 3, 2014 (KR) 10-2014-0067721

(51) Int. Cl. H02J 7/00

(52) U.S. Cl. CPC H02J 7/0029; H02J 2007/0037; H02J 2007/004; H02J 2007/0039

(57) ABSTRACT

Provided is an identification module card mountable in a portable wireless device operating by receiving power supplied from a battery, the identification module card including a battery protection circuit module for detecting and blocking overcharge, overdischarge, and/or overcurrent of the battery, and having embedded at least a part of the battery protection circuit module therein.

### CROSS-REFERENCE TO RELATED PATENT APPLICATION

This application claims the benefit of Korean Patent Application No. 10-2004-0067721, filed on Jun. 3, 2014, in the Korean Intellectual Property Office, the disclosure of which is incorporated herein in its entirety by reference.

### BACKGROUND

1. Field

The present invention relates to an identification module card and a portable wireless device including the same and, more particularly, to a portable wireless device capable of receiving power supplied from a battery, and an identification module card installable in the portable wireless device.

2. Description of the Related Technology

A battery is generally used as a power supply in portable devices such as a mobile phone, smartphone, tablet PC, smartpad, and personal digital assistant (PDA). As the most commonly used battery in the portable devices, a lithium ion battery is heated when overcharge, overdischarge, and/or overcurrent occur, and even has the risk of explosion as well as performance degradation if heating is continued and thus temperature thereof is increased. Accordingly, for a typical battery, a battery protection circuit module for detecting and blocking overcharge, overdischarge, and/or overcurrent may be mounted on a top surface of a battery bear cell. However, since a protection integrated circuit (IC), a field effect transistor (FET), resisters, capacitors, etc. included in the battery protection circuit module occupy an excessively large space, a small battery may not be produced. Furthermore, since a battery pack includes a battery bear cell and a battery protection circuit module mounted on a top surface of the battery bear cell, the capacity of the battery bear cell may be relatively reduced by the volume of the battery protection circuit module, and thus the battery protection circuit module may serve as a limiting factor in implementing a high-capacity battery pack.

Besides, an additional process is required to mount the battery protection circuit module on the battery bear cell. After the battery protection circuit module is mounted, a process for connecting external connection terminals or internal connection terminals thereof through, for example, wires, wire bonding, pattern of a printed circuit board (PCB), or exposed terminals of the PCB is complicated.

In addition, since a typical battery protection circuit module is produced and used based on a battery bear cell, if a new model of a battery bear cell is developed, the existing battery protection circuit module may not be used and thus a lot of research expenses and time are additionally required for development related to the new model.

### SUMMARY

The present invention provides an identification module card including a battery protection circuit module, and a portable wireless device having mounted the identification module card therein, to implement a high-capacity battery pack independent from the model of a battery bear cell. However, the scope of the present invention is not limited thereto.

According to an aspect of the present invention, there is provided an identification module card mountable in a portable wireless device operating by receiving power supplied from a battery, the identification module card including a battery protection circuit module for detecting and blocking overcharge, overdischarge, and/or overcurrent of the battery, and having embedded at least a part of the battery protection circuit module therein.

The identification module card including the battery protection circuit module may be spaced apart from the battery and mountable in the portable wireless device, and electrical connection between the battery protection circuit module and the battery may be achieved through wires provided on a main board of the portable wireless device.

In the identification module card including the battery protection circuit module, the battery protection circuit module may include a protection integrated circuit (IC), a field effect transistor (FET), and one or more passive elements in a body of the identification module card.

In the identification module card including the battery protection circuit module, the battery protection circuit module may include internal connection terminals exposed on a surface of the body of the identification module card, and the internal connection terminals may be electrically connected to the protection IC, the FET, and/or the passive elements, and may be electrically connectable to cell electrodes of the battery through the wires on the main board of the portable wireless device

In the identification module card including the battery protection circuit module, the battery protection circuit module may include external connection terminals exposed on a surface of the body of the identification module card, and the external connection terminals may be electrically connected to the protection IC, the FET, and/or the passive elements, and may be electrically connectable to a charger for charging and to the main board of the portable wireless device for discharging.

In the identification module card including the battery protection circuit module, the battery protection circuit module may configure a battery protection circuit without using a printed circuit board (PCB) by further including a lead frame consisting of a plurality of leads, as a substrate for mounting the protection IC, the FET, and the passive elements thereon, and an electrical connection member for electrically interconnecting any two selected from the group consisting of the protection IC, the FET, and the leads. In this case, the protection IC and the FET may not be inserted into and fixed to the lead frame in a form of a semiconductor package, but may be mounted on and fixed to at least a part of a surface of the lead frame using a surface mounting technology in a form of a chip die not sealed with an encapsulant.

In the identification module card including the battery protection circuit module, the battery protection circuit module may include a PCB as a substrate for mounting the protection IC, the FET, and the passive elements thereon.

According to another aspect of the present invention, there is provided a portable wireless device operating by receiving power supplied from a battery bear cell, and having mounted an identification module card therein. The identification module card may include the battery bear cell, an identification module card spaced apart from the battery bear cell, including a battery protection circuit module for detecting and blocking overcharge, overdischarge, and/or overcurrent of the battery bear cell, and having embedded at least a part of the battery protection circuit module therein, and a main board including wires for electrical connection between the battery protection circuit module and the battery bear cell.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an identification module card including a battery protection circuit module according to an embodiment of the present invention;

FIG. 2 is a partially cut-away perspective view of the identification module card showing that at least part of the battery protection circuit module is embedded in the identification module card, according to an embodiment of the present invention;

FIG. 3 is a circuit diagram showing electrical connections among a battery bear cell, the identification module card including the battery protection circuit module, and a main board in a portable wireless device according to another embodiment of the present invention;

FIG. 4 is a circuit diagram of the battery protection circuit module embedded in the identification module card according to an embodiment of the present invention;

FIG. 5A is a perspective view of an insertion socket capable of mounting therein the identification module card including the battery protection circuit module, according to an embodiment of the present invention;

FIG. 5B is a partially cut-away perspective view of the insertion socket according to an embodiment of the present invention;

FIG. 5C is a cross-sectional view of the insertion socket according to an embodiment of the present invention;

FIG. 6A is a perspective view showing that the identification module card including the battery protection circuit module is mounted in the insertion socket illustrated in FIGS. 5A to 5C; and

FIG. 6B is a partially cut-away perspective view showing that the identification module card including the battery protection circuit module is mounted in the insertion socket illustrated in FIGS. 5A to 5C.

### DETAILED DESCRIPTION

Reference will now be made in detail to exemplary embodiments, examples of which are illustrated in the accompanying drawings. However, exemplary embodiments are not limited to the embodiments illustrated hereinafter, and the embodiments herein are rather introduced to provide easy and complete understanding of the scope and spirit of exemplary embodiments. In the drawings, the thicknesses of layers and regions are exaggerated for clarity.

It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments.

Spatially relative terms, such as “above,” “upper,” “beneath,” “below,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “above” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but may be to include deviations in shapes that result, for example, from manufacturing.

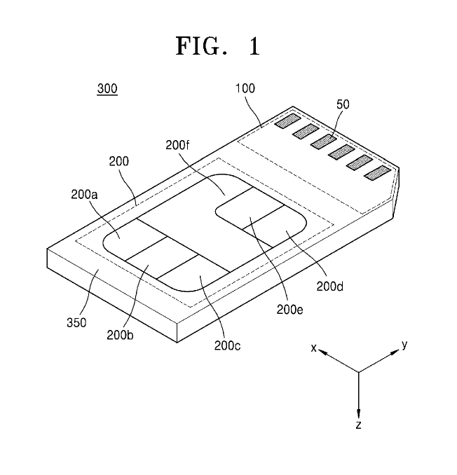

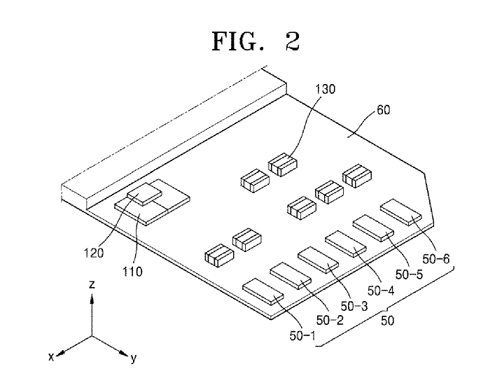

FIG. 1 is a perspective view of an identification module card 300 including a battery protection circuit module 100 according to an embodiment of the present invention, and FIG. 2 is a partially cut-away perspective view of the identification module card 300 showing that at least part of the battery protection circuit module 100 is embedded in the identification module card 300, according to an embodiment of the present invention.

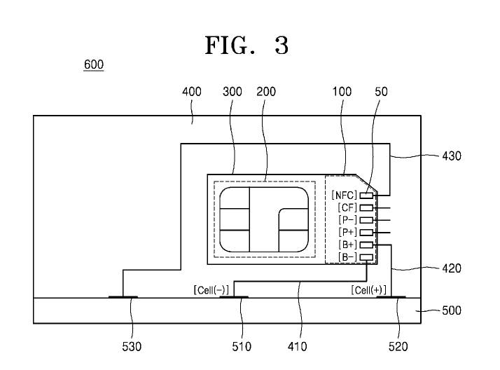

Referring to FIGS. 1 and 2, the identification module card 300 including the battery protection circuit module 100 according to an embodiment of the present invention may be mounted in a portable wireless device 600 (see FIG. 3) capable of operating by receiving power supplied from a battery, e.g., a mobile phone, smartphone, tablet PC, smartpad, or personal digital assistant (PDA).

The identification module card 300 mentioned in this specification may be understood to be one of, for example, a universal subscriber identification module (USIM) card, a subscriber identification module (SIM) card, and a user identification module (UIM) card.

For example, a detachable SIM card may be applied to a European portable wireless device using a global positioning system (GSM). The SIM card may store subscriber information of a device and information related to a device system. Accordingly, irrespective of a device in which the SIM card is mounted, the device may be used based on the information stored in the SIM card. That is, since the SIM card stores, for example, a call history of a user, device settings information of the user, and system information, if the SIM card is connected to and used in another compatible device, the previous user information may also be used in the new device and thus the user may experience convenience. Due to such advantage, a UIM card is currently applied to a code division multiple access (CDMA)-type mobile wireless device.

A USIM card is an enhanced version of the SIM card, and may include a thumbnail-sized chip necessarily inserted into a device for asynchronous 3^{rd} generation (3G) mobile communication (e.g., wideband code division multiple access (WCDMA)). The USIM card serves as a universal integrated circuit card (UICC) capable of functioning as a SIM card for subscriber authentication and including the function of a transportation card or a credit card. The UICC ensures the integrity and security of all kinds of personal data by securely supporting various multi-applications. The USIM card includes a small central processing unit (CPU) and memory. The CPU has an encryption/decryption function to identify a user, and the memory is used as storage for additional services. The function of a credit card, a transportation card, or a membership card may be added into the memory.

The identification module card 300 according to an embodiment of the present invention includes an identification module 200 for a wireless device and the battery protection circuit module 100.

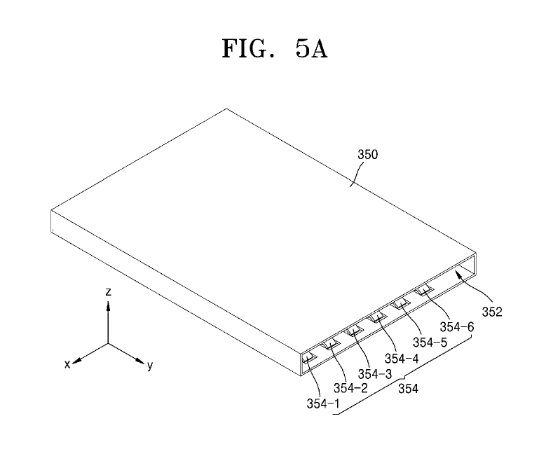

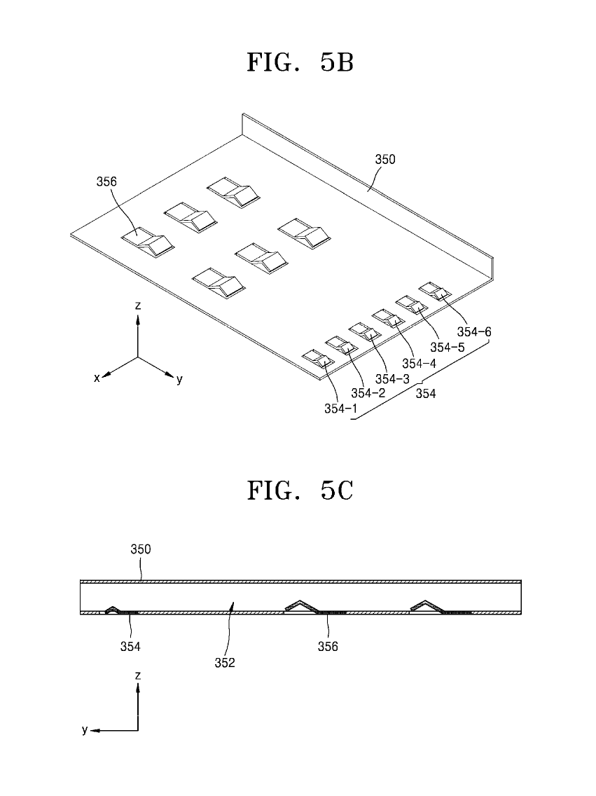

The identification module 200 of the identification module card 300 includes, for example, a plurality of contact pads 200a, 200b, 200c, 200d, 200e, and 200f exposed and provided on a surface of a body 350 of the identification module card 300. The contact pads 200a, 200b, 200c, 200d, 200e, and 200f may physically contact mating connectors 356 (see FIG. 5B) provided in an insertion socket 350 (see FIG. 5B) for mounting the identification module card 300 therein. For example, the contact pads 200a, 200b, 200c, 200d, 200e, and 200f of the identification module 200 may correspond to six contact pads such as GND, VDD, IO, CLK, RST, and VCC. Meanwhile, the identification module 200 may include a small CPU and memory as necessary, and the small CPU and the memory may be embedded in the body 350 of the identification module card 300.

The battery protection circuit module 100 of the identification module card 300 may detect and block overcharge, overdischarge, and/or overcurrent of a battery for supplying power to the portable wireless device 600. The battery protection circuit module 100 may include a protection integrated circuit (IC), a field effect transistor (FET), and one or more passive elements embedded in the body 350 of the identification module card 300.

The battery protection circuit module 100 may include internal connection terminals 50-1, 50-2, and 50-6 formed of a conductive material and exposed on the surface of the body 350 of the identification module card 300. The internal connection terminals 50-1 and 50-2 are electrically connected to the protection IC, the FET, and/or the passive elements embedded in the body 350 of the identification module card 300, at one end. Furthermore, the internal connection terminals 50-1 and 50-2 may be electrically connected to cell electrodes 510 and 520 of a battery bear cell 500 through wires 410 and 420 provided on a main board 400 of the portable wireless device 600, at another end (See also FIG. 3).

In addition, the battery protection circuit module 100 may include external connection terminals 50-3, 50-4, and 50-5 formed of a conductive material and exposed on the surface of the body 350 of the identification module card 300. The external connection terminals 50-3, 50-4, and 50-5 are electrically connected to the protection IC, the FET, and/or the passive elements embedded in the body 350 of the identification module card 300, at one end. Furthermore, the external connection terminals 50-3, 50-4, and 50-5 may be electrically connected to the main board 400 of the portable wireless device 600 for discharging, at another end (See also FIG. 3).

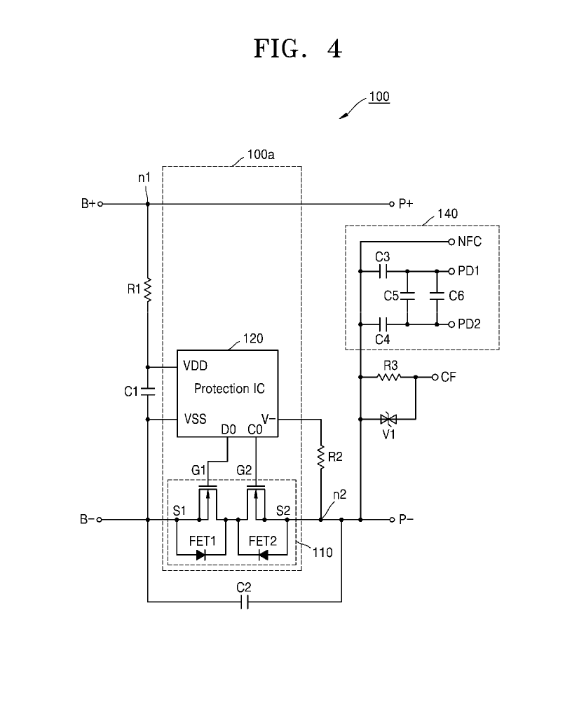

FIG. 3 is a circuit diagram showing electrical connections among the battery bear cell 500, the identification module card 300 including the battery protection circuit module 100, and the main board 400 in the portable wireless device 600 according to another embodiment of the present invention, and FIG. 4 is a circuit diagram of the battery protection circuit module 100 embedded in the identification module card 300 according to an embodiment of the present invention.

Referring to FIG. 3, the identification module card 300 may be mounted in the portable wireless device 600 to be spaced apart from the battery bear cell 500, and electrical connection between the battery protection circuit module 100 and the battery bear cell 500 may be achieved through wires 410, 420, and 430 provided on the main board 400 of the portable wireless device 600. That is, the battery protection circuit module 100 is not bonded to a top surface of the battery bear cell 500 but is at least partially embedded in the identification module card 300 spaced apart from the battery bear cell 500. The circuit configuration of the battery protection circuit module 100 at least partially embedded in the identification module card 300 is now described with reference to FIGS. 3 and 4.

The battery protection circuit module 100 includes first and second internal connection terminals B+ and B− to be connected to the battery bear cell 500, and further includes first to third external connection terminals P+, CF, and P− to be connected to a charger for charging and to be electrically connected to an electronic device (e.g., a portable device) through the main board 400 of the portable wireless device 600 for discharging.

Here, among the first to third external connection terminals P+, CF, and P−, the first and third external connection terminals P+ and P− are used to supply power and the other second external connection terminal CF is used to, for example, detect a battery type and perform changing based on the battery type. In addition, the second external connection terminal CF may be provided as a thermistor for detecting a battery type based on battery temperature when changing, or may be used as a terminal having another function.

The first and second internal connection terminals B+ and B− may be, for example, two (e.g., 50-2 and 50-1) of the connection terminals 50 illustrated in FIG. 2. In addition, the first and third external connection terminals P+ and P− may be, for example, other two (e.g., 50-3 and 50-4) of the connection terminals 50 illustrated in FIG. 2, and the second external connection terminal CF may be the other one (e.g., 50-5) of the connection terminals 50.

The battery protection circuit module 100 may have a connection structure of a dual FET chip 110, a protection IC 120, resisters R1, R2, and R3, a varistor V1, and capacitors C1 and C2 which are embedded in the body 350 of the identification module card 300. One or more passive elements 130 illustrated in FIG. 2 may include elements such as the resisters R1, R2, and R3, and the capacitors C1 and C2 illustrated in FIG. 4. The dual FET chip 110 includes a first FET FET1 and a second FET FET2 having a common drain structure.

The protection IC 120 may be connected to the first internal connection terminal B+ of the battery protection circuit module 100 through the resister R1. Furthermore, the first internal connection terminal B+ may be electrically connected to a positive electrode 520 of the battery bear cell 500 through the wire 420 provided on the main board 400 of the portable wireless device 600.

The protection IC 120 has a terminal (e.g., VDD) connected to the first internal connection terminal B+ serving as (+) terminal of the battery, applying a charge or discharge voltage through a first node n1, and detecting a battery voltage, a reference terminal (e.g., VSS) for providing a reference voltage of an operation voltage inside the protection IC 120, a detection terminal (e.g., V−) for detecting charge/discharge and overcurrent states, a discharge blocking signal output terminal (e.g., DO) for switching off the first FET FET1 in overdischarge state, and a charge blocking signal output terminal (e.g., CO) for switching off the second FET FET2 in overcharge state.

Here, the protection IC 120 includes a reference voltage setter, a comparer for comparing a reference voltage and a charge/discharge voltage to each other, an overcurrent detector, and a charge/discharge detector. Here, a reference for determining the charge or discharge state is variable according to specifications requested by a user, and the charge or discharge state is determined according to the reference by detecting the voltage difference between terminals of the protection IC 120.

The protection IC 120 is configured in such a manner that the terminal DO is changed into LOW state to switch off the first FET FET1 in overdischarge state, that the terminal CO is changed into LOW state to switch off the second FET FET2 in overcharge state, and that the second FET FET2 is switched off when charging and the first FET FET1 is switched off when discharging in overcurrent state.

The resister R1 and the capacitor C1 stabilize variations in power supply of the protection IC 120. The resister R1 is connected between a first node n1 serving as a power (V1) supply node of the battery, and the terminal VDD of the protection IC 120, and the capacitor C1 is connected between the terminal VDD and the terminal VSS of the protection IC 120. Here, the first node n1 is connected to the first internal connection terminal B+ and the first external connection terminal P+. If the resister R1 has a high resistance value, when a voltage is detected, the detected voltage is increased due to a current flowing into the protection IC 120. As such, the resistance value of the resister R1 is set to an appropriate value equal to or less than 1 KΩ. In addition, for stable operation, the capacitor C1 has an appropriate value equal to or greater than 0.01 μF.

The resisters R1 and R2 serve as a current limiter if a charger provides a high voltage exceeding absolute maximum ratings of the protection IC 120 or if the charger is connected with wrong polarity. The resister R2 is connected between the terminal − of the protection IC 120 and a second node n2 connected to a source terminal S2 of the second FET FET2. Since the resisters R1 and R2 are closely related to power consumption, a sum of resistance values of the resisters R1 and R2 is set to be greater than 1 KΩ. In addition, recovery may not occur after overcharge blocking if the resistance value of the resister R2 is excessively large, the resistance value of the resister R2 is set to a value equal to or less than 10 KΩ.

The capacitor C2 is connected between the second node n2 (or the third external connection terminal P−) and a source terminal S1 of the first FET FET1 (or the terminal VSS or the second internal connection terminal B−). The capacitor C2 does not exert a strong influence on product features of the battery protection circuit module 100, but is added upon a request of the user or for stability. The capacitor C2 is used to achieve system stabilization by improving a tolerance to voltage variations or external noise.

The resister R3 and the varistor V1 are elements for electrostatic discharge (ESD) and surge protection, and are connected in parallel to each other between the second external connection terminal CF and the second node n2 (or the third external connection terminal P−). The varistor V1 is an element for reducing resistance thereof when overvoltage occurs, to minimize, for example, circuit damage due to overvoltage.

The protection IC 120 may be connected to the second internal connection terminal B− of the battery protection circuit module 100 through the terminal VSS. Furthermore, the second internal connection terminal B− may be electrically connected to a negative electrode 510 of the battery bear cell 500 through the wire 410 provided on the main board 400 of the portable wireless device 600.

Meanwhile, the above-described battery protection circuit module 100 may additionally include a near field communication (NFC) circuit 140 to support NFC communication. The NFC circuit 140 may include, for example, an NFC external connection terminal NFC, NFC access terminals PD1 and PD2, and/or NFC matching elements C3, C4, C5, and C6. When two ends of an NFC antenna contact the NFC access terminals PD1 and PD2, the NFC matching elements C3, C4, C5, and C6 may be electrically connected to the NFC antenna to form a closed loop. The NFC matching elements C3, C4, C5, and C6 may be, for example, capacitors for frequency matching. For example, the two ends of the NFC antenna may be connected to the capacitors C3, C4, C5, and C6 serving as NFC matching elements to form a closed loop, and a frequency region of 13.56 MHz may be generated for NFC communication using resonance occurring from the NFC antenna and the capacitors C3, C4, C5, and C6, thereby performing communication with an NFC device. A terminal NFC illustrated in FIG. 3 may be the NFC external connection terminal NFC or the NFC access terminals PD1 and PD2 illustrated in FIG. 4.

Meanwhile, the battery bear cell 500 includes an electrode assembly and a cap assembly. The electrode assembly may include a positive electrode plate formed by coating a positive electrode active material on a positive electrode current collector, a negative electrode plate formed by coating a negative electrode active material on a negative electrode current collector, and a separator disposed between the positive electrode plate and the negative electrode plate to prevent a short circuit between the two electrode plates and to allow lithium ions to move. A positive electrode tap adhered to the positive electrode plate and a negative electrode tap adhered to the negative electrode plate protrude from the electrode assembly.

The cap assembly includes a negative electrode terminal 510, a gasket (not shown), and a cap plate 520. The cap plate 520 may serve as a positive electrode terminal. The negative electrode terminal 510 may also be called a negative electrode cell or an electrode cell. The gasket may be formed of an insulating material to insulate the negative electrode terminal 510 and the cap plate 520 from each other. Accordingly, electrode terminals of the battery bear cell 500 may include the negative electrode terminal 510 and the cap plate 520.

Referring to FIG. 2, the dual FET chip 110, the protection IC 120, and the passive elements 130 embedded in the body 350 of the identification module card 300 to form the battery protection circuit module 100 may be mounted on a substrate 60.

For example, the substrate 60 on which the dual FET chip 110, the protection IC 120, and the passive elements 130 are mounted may be a printed circuit board (PCB).

Alternatively, the substrate 60 for mounting the dual FET chip 110, the protection IC 120, and the passive elements 130 thereon may be a lead frame consisting of a plurality of leads. In embodiments of the present invention, the lead frame is formed by patterning lead terminals on a metal frame, and may be distinguished in terms of structure, thickness, etc. from the PCB in which a metal wiring layer is formed on an insulating core. In this case, the battery protection circuit module 100 may configure a battery protection circuit without using a PCB by further including an electrical connection member (e.g., bonding wire or bonding ribbon) for electrically interconnecting any two selected from the group consisting of the dual FET chip 110, the protection IC 120, the passive elements 130, and the leads. Furthermore, the dual FET chip 110 and the protection IC 120 may not be inserted into and fixed to the lead frame in the form of a semiconductor package, but may be mounted on and fixed to at least a part of the surface of the lead frame using a surface mounting technology in the form of a chip die not sealed with an encapsulant. Compared to a case when the dual FET chip 110, the protection IC 120, and the passive elements 130 are mounted on the PCB, if the substrate 60 is configured using only the lead frame, a total height may be greatly reduced. That is, since the PCB typically has a thickness of about 2 mm while the lead frame has a thickness of about 0.8 mm, the lead frame is more advantageous to mount the dual FET chip 110, the protection IC 120, and the passive elements 130 in the body 350 of the identification module card 300 restricted to a certain height.

The above-described configuration of the battery protection circuit module 100 according to the previous embodiments of the present invention is exemplary, and the configuration, number, location, etc. of connection terminals, protection ICs, FETs or passive elements may appropriately vary according to additional functions of the battery protection circuit module 100.

A description is now given of the configuration of the insertion socket 350 capable of mounting therein the identification module card 300 including the above-described battery protection circuit module 100.

FIG. 5A is a perspective view of the insertion socket 350 capable of mounting therein the identification module card 300 including the battery protection circuit module 100, according to an embodiment of the present invention, FIG. 5B is a partially cut-away perspective view of the insertion socket 350 according to an embodiment of the present invention, and FIG. 5C is a cross-sectional view of the insertion socket 350 according to an embodiment of the present invention.

The insertion socket 350 has an internal space 352 into which the above-described the identification module card 300 is inserted and mounted. In addition, the insertion socket 350 includes first and second mating connectors 354 and 356 electrically connected to the main board 400, on a bottom surface thereof. The first mating connectors 354-1, 354-2, 354-3, 354-4, 354-5, and 354-6 of the insertion socket 350 may be correspondingly connected to the connection terminals 50-1, 50-2, 50-3, 50-4, 50-5, and 50-6 of the identification module card 300. The second mating connectors 356 of the insertion socket 350 may be correspondingly connected to the contact pads 200a, 200b, 200c, 200d, 200e, and 200f of the identification module card 300.

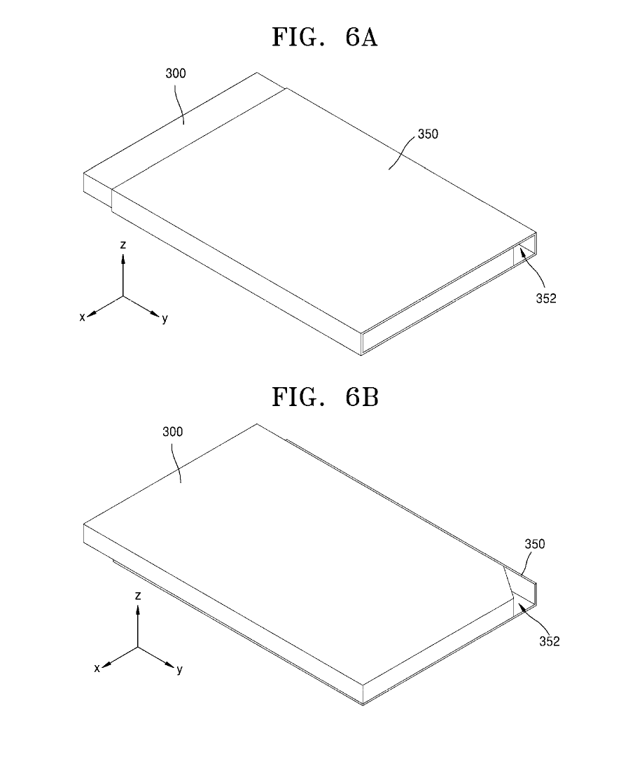

FIG. 6A is a perspective view showing that the identification module card 300 including the battery protection circuit module 100 is mounted in the insertion socket 350 illustrated in FIGS. 5A to 5C, and FIG. 6B is a partially-cut perspective view showing that the identification module card 300 including the battery protection circuit module 100 is mounted in the insertion socket 350 illustrated in FIGS. 5A to 5C.

Referring to FIGS. 6A and 6B, by mounting the identification module card 300 including the battery protection circuit module 100 in the internal space 352 of the insertion socket 350, contact pads and connection terminals provided on the surface of the body 350 of the identification module card 300 may be electrically connected to mating connectors of the insertion socket 350, and thus the identification module 200 and the battery protection circuit module 100 of the identification module card 300 may be activated.

The configuration of the identification module card 300 including the battery protection circuit module 100 has been described above. A description is now given of advantageous effects expected due to this configuration.

Firstly, the capacity of the battery bear cell 500 may be increased. Since a battery pack typically includes a battery bear cell and a battery protection circuit module mounted on a top surface of the battery bear cell, the capacity of the battery bear cell may be relatively reduced by the volume of the battery protection circuit module, and thus the battery protection circuit module may serve as a limiting factor in implementing a high-capacity battery pack. However, according to embodiments of the present invention, since the battery protection circuit module 100 is spaced apart from a battery pack, the volume of the battery bear cell 500 in the battery pack may be increased by the volume of the battery protection circuit module 100, and thus the capacity of the battery bear cell 500 may be increased.

Secondly, a process for bonding the battery protection circuit module 100 on a top surface of the battery bear cell 500 may be omitted and thus process simplification may be achieved. Typically, the battery protection circuit module 100 may be bonded to the top surface of the battery bear cell 500 in the form of a package using any one method selected from the group consisting of laser welding, resistance welding, soldering, conductive adhesive, and conductive tape. The top surface of the battery bear cell 500 has a narrow area and thus the above-described bonding process may not be easily performed thereon. In addition, since a mechanical bonding strength after bonding is low, structural instability may be caused. However, according to embodiments of the present invention, since the battery protection circuit module 100 is provided in the identification module card 300 having a relative large area, the possibility that a defect is caused by a bonding process is low.

Thirdly, a battery protection circuit module which is independent from the shape or model of a battery bear cell may be provided. Since a typical battery protection circuit module is manufactured based on the area of a top surface of a battery bear cell, and the location or size of electrode terminals provided on the battery bear cell, if a new model of a battery bear cell is developed, the existing battery protection circuit module may not be used and thus a lot of research expenses and time are additionally required for development related to the new model. However, according to embodiments of the present invention, since the battery protection circuit module 100 is provided in the identification module card 300 and electrical connection between the battery protection circuit module 100 and the battery bear cell 500 is achieved through wires provided on the main board 400, a single model of the battery protection circuit module 100 may be used in various models of the battery bear cell 500.

As described above, according to an embodiment of the present invention, a battery protection circuit module independent from the model of a battery bear cell and capable of increasing the capacity of the battery bear cell may be implemented by embedding at least a part of the battery protection circuit module in an identification module card. However, the scope of the present invention is not limited to the above-described effect.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An identification module card mountable in a portable wireless device operating by receiving power supplied from a battery, the identification module card comprising: a battery protection circuit module for detecting and blocking overcharge, overdischarge and/or overcurrent of the battery.

2. The identification module card of claim 1, wherein the identification module card is spaced apart from the battery and mountable in the portable wireless device, and
wherein electrical connection between the battery protection circuit module and the battery is achieved through wires provided on a main board of the portable wireless device.

3. The identification module card of claim 1, wherein the battery protection circuit module comprises a protection integrated circuit (IC), a field effect transistor (FET), and one or more passive elements in a body of the identification module card.

4. The identification module card of claim 3, wherein the battery protection circuit module comprises internal connection terminals exposed on a surface of the body of the identification module card, and
wherein the internal connection terminals are electrically connected to the protection IC, the FET, and/or the passive elements, and are electrically connectable to cell electrodes of the battery through the wires on the main board of the portable wireless device

5. The identification module card of claim 3, wherein the battery protection circuit module comprises external connection terminals exposed on a surface of the body of the identification module card, and
wherein the external connection terminals are electrically connected to the protection IC, the FET, and/or the passive elements, and are electrically connectable to the main board of the portable wireless device for discharging.

6. The identification module card of claim 3, wherein the battery protection circuit module configures a battery protection circuit without using a printed circuit board (PCB) by further comprising:
a lead frame consisting of a plurality of leads, as a substrate for mounting the protection IC, the FET, and the passive elements thereon; and
an electrical connection member for electrically interconnecting any two selected from the group consisting of the protection IC, the FET, and the leads.

7. The identification module card of claim 6, wherein the protection IC and the FET are not inserted into and fixed to the lead frame in a form of a semiconductor package, but are mounted on and fixed to at least a part of a surface of the lead frame using a surface mounting technology in a form of a chip die not sealed with an encapsulant.

8. The identification module card of claim 3, wherein the battery protection circuit module comprises a PCB as a substrate for mounting the protection IC, the FET, and the passive elements thereon.

9. A portable wireless device operating by receiving power supplied from a battery pack, and having mounted an identification module card therein,
wherein the identification module card comprises an identification module and a battery protection circuit module,
wherein at least a part of the battery protection circuit module is embedded in the identification module card spaced apart from the battery pack, and
wherein electrical connection between the battery protection circuit module and the battery pack is achieved through wires provided on a main board of the portable wireless device.

10. The portable wireless device of claim 9, further comprising an insertion socket capable of mounting the identification module card therein and comprising first mating connectors and second mating connectors electrically connected to the main board,
wherein the first mating connectors contact contact pads of the identification module of the identification module card, and
wherein the second mating connectors contact connection terminals of the battery protection circuit module of the identification module card.
